SEQUENCE LISTING (7 sequences)

SEQ ID NO: 1 - protein, 269 aa, Bacillus  lentus (subtilisin 309)
AQTVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus Lentus ATCC 53926; identical to SEQ ID NO: 1

SEQ ID NO: 3 - protein, 268 aa, Bacillus lentus
QTVPWGISFINTQQAHNRGIFGNGARVAVLDTGIASHPDLRIAGGASFISSEPSYHDNNGHGTHVAGTIAALNNSIGVLGVAPSADLYAVKVLDRNGSGSLASVAQGIEWAINNNMHIINMSLGSTSGSSTLELAVNRANNAGILLVGAAGNTGRQGVNYPARYSGVMAVAAVDQNGQRASFSTYGPEIEISAPGVNVNSTYTGNRYVSLSGTSMATPHVAGVAALVKSRYPSYTNNQIRQRINQTATYLGSPSLYGNGLVHAGRATQ

SEQ ID NO: 4 - protein, 269 aa, Thermomyces lanuginosus [sequence omitted]

SEQ ID NO: 5 - protein, 269 aa, Thermomyces lanuginosus [sequence omitted]

SEQ ID NO: 6 - protein, 268 aa, Artificial Sequence; identical to SEQ ID NO: 3
  protease

SEQ ID NO: 7 - protein, 269 aa, artificial [sequence omitted]

(19) United States
(12) Patent Application Publication
(10) Pub. No.: US 2017/0121644 A1
(43) Pub. Date: May 4, 2017

(54) Organic Film Removal From Plastic Objects

(71) Applicant: Novozymes A/S, Bagsvaerd (DK)

(72) Inventor: Nicholas Bagger Gurieff, Bagsvaerd (DK)

(73) Assignee: Novozymes A/S, Bagsvaerd (DK)

(21) Appl. No.: 15/319,043

(22) PCT Filed: Jul. 7, 2015
(86) PCT No.: PCT/EP2015/065438

§ 371 Date: Dec. 15, 2016

(30) Foreign Application Priority Data
Jul. 8, 2014 (EP) 14176139.5
Apr. 9, 2015 (EP) 15163034.0

(51) Int. Cl. C11D 3/386; C11D 3/20; C11D 11/00

(52) U.S. Cl. CPC C11D 3/386; C11D 11/0035; C11D 3/38627; C11D 3/2086; C12Y 301/01003; C12Y 304/21062

(57) ABSTRACT

The present invention concerns a method for cleaning an object made wholly or in part of a plastic, comprising contacting said object/said plastic with a liquid composition comprising one or more enzymes. The invention further concerns use of one or more enzymes for prolonging the lifetime of an object made wholly or in part of a plastic. Finally, the invention concerns a composition and a kit of parts comprising one or more enzymes.

### REFERENCE TO A SEQUENCE LISTING

This application contains a Sequence Listing in computer readable form, which is incorporated herein by reference.

### FIELD OF THE INVENTION

The present invention concerns means and methods for cleaning an object made wholly or in part of a plastic or for prolonging the lifetime of such an object, comprising contacting said object/said plastic with a composition comprising one or more enzymes.

Additionally, the invention provides compositions and kits of parts comprising:

I) One or more enzymes as defined herein, and

II) one or more detergents and/or one or more chemicals as defined herein;

as well as methods of making such compositions.

### BACKGROUND OF THE INVENTION

For certain purposes, objects such as kitchen utensils, cooking utensils, eating utensils and tableware made wholly or partly of plastic provides great advantages. For instance, there is a lower risk of accidents and physical damage, e.g. damage from broken glass, and the work environment clearly benefits from the fact that the objects weigh less so that carrying and handling the items is less strenuous. In some countries, the authorities also consider, for safety reasons, to bann the use of glass cups or mugs at bars and restaurants serving alcoholic beverages, requiring that they of cups made of plastic.

Polycarbonate in particular, is a wonderfully attractive material for such purpose and provides multiple benefits to the user when compared to porcelain or glass: It is clear, resistant to breakage and light weight. However, objects made from polycarbonate and other plastics have a tendency for “surface activity” with various chemicals, which are either present in the beverages, the objects are used for, or in industrial and institutional (I&I) warewash processes.

As a result, complaints are received about formation of organic film on the surface of plastic cups and flavour continuation after wash. Organic film formation and flavor continuation can be ascribed, at least in part, to molecules which are esters, such as key flavor molecules in coffee, tea, creamers, sugars etc.

The organic film and the flavor are resistant to removal using common warewash chemicals, specialty coffee cleaners, scale removing chemicals and other general purpose cleaning detergents and chemicals. The only solution has been to physically remove the film using a scouring pad, which in turn damages and disfigures the mugs.

Therefore, novel means and methods are highly demanded for cleaning objects made wholly or in part of plastic, such that organic film formation on the surface of the plastic is prevented or reduced or such that organic film already formed is removed.

### SUMMARY OF THE INVENTION

The present invention concerns a method for cleaning an object made wholly or in part of a plastic, comprising contacting said object/said plastic with a liquid composition comprising one or more enzymes.

The invention further concerns use of one or more enzymes for prolonging the lifetime of an object made wholly or in part of a plastic, such as an object selected from the group consisting of kitchen utensils, cooking utensils, eating utensils, tableware.

Further is claimed a composition comprising:

III) one or more enzymes as defined herein, and

IV) one or more detergents and/or one or more chemicals as defined herein.

The invention also provides a kit of parts comprising:

I) one or more enzymes as defined herein; and

II) one or more detergents and/or one or more chemicals as defined herein.

Finally, the invention also provides methods of making compositions according to the invention.

### DEFINITIONS

Descaling agent or chemical descaler refers to a chemical substance used to remove limescale, such as from metal surfaces in contact with hot water, such as in boilers, water heaters, and kettles. Descaling agents are typically acidic compounds that react with the alkaline carbonate compounds present in the scale, producing carbon dioxide gas and a soluble salt.

Water softener or scale inhibitor refers to any substance which when added to water containing calcium and magnesium ions cause the ions to precipitate or change their usual properties. Water softeners are generally used in the purification of water for the laboratory, and for giving water more efficient sudsing ability with soap.

Automatic dishwashing (ADW) detergent composition refers to compositions comprising detergent components, which composition is intended for cleaning dishware such as plates, cups, glasses, bowls, cutlery such as spoons, knives, forks, serving utensils, ceramics, plastics, metals, china, glass and acrylics in a dishwashing machine. The terms encompass any materials/compounds selected for domestic or industrial washing applications and the form of the product can be liquid, powder or granulate.

Detergent components: The term “detergent components” is defined herein to mean the types of chemicals which can be used in detergent compositions for automatic dishwashing. Examples of detergent components are polymers, bleaching systems, bleach activators, bleach catalysts, silicates, dyestuff and metal care agents.

Wash cycle: The term “wash cycle” is defined herein as a washing operation wherein dishware are exposed to the wash liquor for a period of time by circulating the wash liquor and spraying the wash liquor onto the dishware in order to clean the dishware and finally the superfluous wash liquor is removed. A wash cycle may be repeated one, two, three, four, five or even six times at the same or at different temperatures. Hereafter the dishware is generally rinsed and dried. One of the wash cycles can be a soaking step, where the dishware is left soaking in the wash liquor for a period.

Wash liquor: The term “wash liquor” is defined herein as the solution or mixture of water and detergent components, such as detergent components of an automated dishwashing detergent composition. The wash liquour optionally one or more of the enzymes used according to the Invention.

Sequence identity: The relatedness between two amino acid sequences or between two nucleotide sequences is described by the parameter “sequence identity

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

Variant: The term “variant” means a polypeptide having enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively.

Deletions. For an amino acid deletion, the following nomenclature is used: Original amino acid, position,*. Accordingly, the deletion of glycine at position 195 is designated as “Glyl95*” or “G195*”. Multiple deletions are separated by addition marks (“+”), e.g., “Glyl95*+Ser411*” or “G195*+S411*”.

Insertions. For an amino acid insertion, the following nomenclature is used: Original amino acid, position, original amino acid, inserted amino acid. Accordingly the insertion of lysine after glycine at position 195 is designated “Glyl95GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Glyl95GlyLysAla” or “G195GKA”.

In such cases, the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple alterations. Variants comprising multiple alterations are separated by addition marks (“+”), e.g., “Arg170Tyr+Glyl95Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants: “Tyr167Gly+Arg170Gly”, “Tyr167Gly+Arg170Ala”, “Tyr167Ala+Arg170Gly”, and “Tyr167Ala+Arg170Ala”.

### DETAILED DESCRIPTION OF THE INVENTION

### Method for Cleaning

The present inventors have observed that enzymes are useful for cleaning objects made wholly or in part of plastic, such that organic film formation on the surface of the plastic is prevented or reduced or such that organic film already formed is removed. Hence, in a first aspect, the present invention pertains to a method for cleaning an object made wholly or in part of a plastic, comprising contacting said object/said plastic with a composition comprising one or more enzymes. Preferably, the composition comprising said one or more enzymes is a liquid composition.

The method according to the invention may be for complete or partial removal of a film, such as an organic film, on said plastic; i.e. when using the method according to the invention a film, such as an an organic film, on said plastic is completely or partially removed.

Without being bound by theory, the inventors believe that organic compounds, such as esters, amino acids, peptides and proteins are included in the film and that limescale also plays a role in organic film formation. Hence, the film, which is removed or reduced or of which build-up is prevented, may in particular comprise comprises calcium carbonate (CaCO₃) and magnesium carbonate (MgCO₃), magnesium hydroxide (Mg(OH)₂), calcium sulfate (CaSO₄) and other carbonates, and one or more organic compounds, such as one or more compounds selected from the group consisting of esters, amino acids, peptides and proteins.

Further, the method according to the invention is also for reduction or removal of malodor. This will enhance the drinking or eating experience for the next user of the item because no carry over of flavor is present.

In the method according to the invention, the said object may be selected from the group consisting of kitchen utensils, cooking utensils, eating utensils and tableware.

In particular embodiments of the invention, the object is contacted with said one or more enzymes in a soaking step. The soaking may be performed by immersing the object in the composition comprising one or more enzymes, by wetting the object with the composition comprising one or more enzymes e.g. by spraying the composition onto the object; by dipping the object in the composition comprising one or more enzymes, followed by leaving the object for the period, or by other methods where the object is in contact with the composition comprising one or more enzymes for a selected holding period. No particular action is required during the holding period, even though it may be beneficial to agitate object or the composition during the period.

The object may be contacted with said one or more enzymes in a soaking step, wherein the total amount of said one or more enzymes in said liquid composition is within the range of 0.05-5% (w/w), such as within the range of 0.05-4% (w/w), 0.05-3% (w/w), 0.05-2% (w/w), 0.05-1% (w/w), 0.05-0.5% (w/w), 0.05-0.25% (w/w), 0.05-0.1% (w/w), 0.1-5% (w/w), 0.1-4% (w/w), 0.1-3% (w/w), 0.1-2% (w/w), 0.1-1% (w/w), 0.1-0.5% (w/w), 0.15-% (w/w), 0.15-4% (w/w), 0.15-3% (w/w), 0.15-2% (w/w), 0.15-1% (w/w), 0.15-0.75% (w/w), 0.15-0.5% (w/w), 0.15-0.25% (w/w), 0.25-5% (w/w), 0.25-4% (w/w), 0.25-3% (w/w), 0.25-2% (w/w), 0.25-1% (w/w), 0.25-0.5% (w/w), 0.5-4% (w/w), 0.5-3% (w/w), 0.5-2% (w/w), 0.5-1% (w/w), 0.75-4% (w/w), 0.75-3% (w/w), 0.75-2% (w/w), 0.75-1% (w/w), 1-5% (w/w), 1-4% (w/w), 1-3% (w/w), 1-2% (w/w), 1.25-5% (w/w), 1.25-4% (w/w), 1.25-3% (w/w), 1.25-2% (w/w), 1.5-5% (w/w), 1.5-4% (w/w), 1.5-3% (w/w), 1.5-2% (w/w), 2-5% (w/w), 2-4% (w/w), 2-3% (w/w), 3-5% (w/w), 3-4% (w/w), or such as 4-5% (w/w).

In particular embodiments, the said or more enzymes may be selected from the group consisting of proteases and lipases.

The combination of lipase and protease can nearly remove 100% of the film and return the material to an “as new” appearance. This can be obtained without any physical labour, so it is possible to save costs in the washing process. This was achieved without applying any harsh treatments that can damage the surface of the item.

In additional embodiments, the invention provides a process, in which said object is contacted with one or more proteases and one or more lipases, such as one protease and one lipase, one protease and two lipases, one protease and three lipases, two proteases and one lipase, two proteases and two lipases, two proteases and three lipases, three proteases and one lipase, three proteases and two lipases or three proteases and three lipases.

In further embodiments, 5-50% (w/w) of the amount of enzyme is protease, such as 5-40% n(w/w), 5-30% (w/w), 5-20% (w/w), 5-15% (w/w), 5-10% (w/w), 10-50% (w/w), 10-40% (w/w), 10-30% (w/w), 10-20% (w/w), 15-50% (w/w), 15-40% (w/w) or 15-30% (w/w) of the amount of enzyme is protease. For certain purposes, it may be preferred that 10-20% (w/w) of the amount of enzyme is protease.

In still further embodiments, 50-95% (w/w) of the amount of enzyme is lipase, such as 60-95% (w/w), 70-95% (w/w), 80-95% (w/w), 90-95% (w/w), 50-90% (w/w), 60-90% (w/w), 70-90% (w/w), 80-90% (w/w), 50-80% (w/w), 60-80% (w/w) or 70-80% (w/w), of the amount of enzyme is lipase. For certain purposes it may be preferred that 80-90% (w/w) of the amount of enzyme is lipase.

The said liquid composition may in particular comprise 0.025-2.5% (w/w) protease, such as 0.025-2% (w/w), 0.025-1.5% (w/w), 0.025-1.25% (w/w), 0.025-0.75% (w/w), 0.025-0.5% (w/w), 0.025-0.25% (w/w), 0.025-0.1% (w/w), 0.025-0.05% (w/w), 0.05-2.5% (w/w), 0.05-2% (w/w), 0.05-1.5% (w/w), 0.05-1.25% (w/w), 0.05-0.75% (w/w), 0.05-0.5% (w/w), 0.05-0.25% (w/w), 0.05-0.1% (w/w), 0.01-2.5% (w/w), 0.1-2% (w/w), 0.1-1.5% (w/w), 0.1-1.25% (w/w), 0.1-1% (w/w), 0.1-0.75% (w/w), 0.1-0.25% (w/w), 0.15-2.5% (w/w), 0.15-2% (w/w), 0.15-1.5% (w/w), 0.15-1.25% (w/w), 0.15-1% (w/w), 0.15-0.75% (w/w), 0.15-0.5% (w/w), 0.15-0.25% (w/w), 0.25-2.5% (w/w), 0.25-2% (w/w), 0.25-1.5% (w/w), 0.25-1.25% (w/w), 0.25-1% (w/w), 0.25-0.5% (w/w), 0.5-2.5% (w/w), 0.5-2% (w/w), 0.5-1.5% (w/w), 0.5-1.25% (w/w), 0.5-1% (w/w), 0.5-0.75% (w/w), 0.75-2.5% (w/w), 0.75-2% (w/w), 0.75-1.5% (w/w), 0.75-1.25% (w/w), 0.75-1% (w/w), 1-2.5% (w/w), 1-2% (w/w), 1-1.5% (w/w), 1-1.25% (w/w), 1.25-2.5% (w/w), 1.25-2% (w/w), 1.25-1.5% (w/w), 1.5-2.5% (w/w), 1.5-2% (w/w), 1.5-1.75% (w/w), or such as 2-2.5% (w/w) protease.

Also, the said liquid composition may comprise 0.025-5% (w/w) lipase, such as 0.025-4% (w/w), 0.025-3% (w/w), 0.025-2% (w/w), 0.025-1% (w/w), 0.025-0.5% (w/w), 0.025-0.25% (w/w), 0.025-0.1% (w/w), 0.025-0.05% (w/w), 0.05-5% (w/w), such as within the range of 0.05-4% (w/w), 0.05-3% (w/w), 0.05-2% (w/w), 0.05-1% (w/w), 0.05-0.5% (w/w), 0.05-0.25% (w/w), 0.05-0.1% (w/w), 0.1-5% (w/w), 0.1-4% (w/w), 0.1-3% (w/w), 0.1-2% (w/w), 0.1-1% (w/w), 0.1-0.5% (w/w), 0.15-% (w/w), 0.15-4% (w/w), 0.15-3% (w/w), 0.15-2% (w/w), 0.15-1% (w/w), 0.15-0.75% (w/w), 0.15-0.5% (w/w), 0.15-0.25% (w/w), 0.25-5% (w/w), 0.25-4% (w/w), 0.25-3% (w/w), 0.25-2% (w/w), 0.25-1% (w/w), 0.25-0.5% (w/w), 0.5-4% (w/w), 0.5-3% (w/w), 0.5-2% (w/w), 0.5-1% (w/w), 0.75-4% (w/w), 0.75-3% (w/w), 0.75-2% (w/w), 0.75-1% (w/w), 1-5% (w/w), 1-4% (w/w), 1-3% (w/w), 1-2% (w/w), 1.25-5% (w/w), 1.25-4% (w/w), 1.25-3% (w/w), 1.25-2% (w/w), 1.5-5% (w/w), 1.5-4% (w/w), 1.5-3% (w/w), 1.5-2% (w/w), 2-5% (w/w), 2-4% (w/w), 2-3% (w/w), 3-5% (w/w), 3-4% (w/w), or such as 4-5% (w/w) lipase.

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the 51 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further useful protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of other useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V4I, S9R, A15T, K27R, *36D, V68A, N76D, N87S,R, *97E, A98S, S99G,D,A, S99AD, S101G,M,R S103A, V104I,Y,N, S106A, G118V,R, H120D,N, N123S, S128L, P129Q, S130A, G160D, Y167A, R170S, A194P, G195E, V199M, V205I, L217D, N218D, M222S, A232V, K235L, Q236H, Q245R, N252K, T274A (using BPN′ numbering).

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes NS), those sold under the tradename Maxatase®, Maxacal®, Maxapem®, Purafect®, Purafect Prime®, Preferenz™, Purafect MA®, Purafect Ox®, Purafect OxP®, Puramax®, Properase®, Effectenz™, FN2®, FN3®, FN4®, Excellase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

At least, one of said one or more proteases may be an alkaline protease, such as a subtilisin.

Some currently preferred proteases are Bacillus lentus proteinase (Esperase® 8.0L), and Bacillus subtilis alkaline proteinase (Savinase).

Suitable lipases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Useful commercial lipase products include include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the 554V variant used in the commercial product Gentle Power Bleach from Huntsman Textile Effects Pte Ltd (WO10/100028).

In a currently preferred embodiment, one of said one or more lipases is Lipex100L.

In further currently preferred embodiments, the said protease is Bacillus lentus proteinase (Esperase 80L) or Bacillus subtilis alkaline proteinase (savinase) and said lipase is Lipex100L.

At least, one of the proteases used in the method according to the invention may in particular be selected from the group consisting of:
(a) a polypeptide comprising or consisting of the amino acid sequence set forth in any one of SEQ ID NO: 1; SEQ ID NO: 2, SEQ ID NO: 3 and SEQ ID NO: 6;
(b) a polypeptide which is a subsequence of the amino acid sequence set forth in any one of SEQ ID NOs: 1, 2, 3 and 6;
(c) a polypeptide having at least 60% sequence identity, such as e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, to any of the polypeptides defined in (a) and (b).

The protease defined in item (c) may have an amino acid sequence which differs by up to 40 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 from the polypeptide of any one of SEQ ID NOs: 1, 2, 3 and 6.

The protease may be a variant of SEQ ID NO: 1 wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering.

The protease may be a variant of SEQ ID NO: 2 wherein the polypeptide comprises a substitution in one or more of positions: 3, 4, 99, 101, 103, 104, 159, 194, 199, 205 and/or 217.

In a further embodiment, at least one said lipases is selected from the group consisting of
(a) a polypeptide comprising or consisting of the amino acid sequence set forth in SEQ ID NO: 4, SEQ ID NO: 5 or SEQ ID NO 7;
(b) a polypeptide which is a subsequence of the amino acid sequence set forth in SEQ ID NO: 4, 5 or 7;
(c) a polypeptide having at least 60% sequence identity, such as e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, to any of the polypeptides set forth in (a) and (b).

The lipase set forth in (c) may be a variant the amino acid sequence set forth in SEQ ID NO: 4, wherein the polypeptide comprises the following substitutions T231R and N233R.

The lipase set forth in item (c) may have an amino acid sequence which differs by up to 40 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 from the polypeptide of SEQ ID NO: 4 or 5.

The lipase may be a variant of a parent lipase, which variant has lipase activity and has at least 60%, such at least 65%, at least 70%, at least 75%, at least 80%, at least 85%, at least 90%, at least 95% identity, at least 96%, at least 97%, at least 98%, or at least 99%, but less than 100% sequence identity with SEQ ID NO: 5, and comprises substitutions at positions corresponding to T231R+N233R and at least one or more (e.g., several) of D96E, D111A, D254S, G163K, P256T, G91T, G38A, D27R, and N33Q of SEQ ID NO: 5.

In a further embodiment, the lipase is a variant having lipase activity and at least 60% such at least 65%, at least 70%, at least 75%, at least 80%, at least 85%, at least 90%, at least 95% identity, at least 96%, at least 97%, at least 98%, or at least 99%, but less than 100% sequence identity with SEQ ID NO: 5, and comprises substitutions at positions corresponding to T231R+N233R and at least one or more (e.g., several) of D96E, D111A, D254S, G163K, P256T, G91T, G38A, D27R, and N33Q of SEQ ID NO: 5 selected from the group of:
a) D96E T231R N233R;
b) N33Q D96E T231R N233R;
c) N33Q T231R N233R;
d) N33Q D111A T231R N233R;
e) N33Q T231R N233R P256T;
f) N33Q G38A G91T G163K T231R N233R D254S;
g) N33Q G38A G91T D96E D111A G163K T231R N233R D254S P256T;
h) D27R N33Q G38A D96E D111A G163K T231R N233R D254S P256T;
i) D27R N33Q G38A G91T D96E D111A G163K T231R N233R P256T;
j) D27R N33Q G38A G91T D96E D111A G163K T231R N233R D254S;
k) D27R G38A G91T D96E D111A G163K T231R N233R D254S P256T;
l) D96E T231R N233R D254S;
m) T231R N233R D254S P256T;
n) G163K T231R N233R D254S;
o) D27R N33Q G38A G91T D96E G163K T231R N233R D254S P256T;
p) D27R G91T D96E D111A G163K T231R N233R D254S P256T;
q) D96E G163K T231R N233R D254S;
r) D27R G163K T231R N233R D254S;
s) D27R G38A G91T D96E D111A G163K T231R N233R D254S;
t) D27R G38A G91T D96E G163K T231R N233R D254S P256T;
u) D27R G38A D96E D111A G163K T231R N233R D254S P256T:
v) D27R D96E G163K T231R N233R D254S;
w) D27R D96E D111A G163K T231R N233R D254S P256T;
x) D27R G38A D96E G163K T231R N233R D254S P256T.

In further embodiments of the invention, the said object and/or the said plastic is contacted with said one or more enzymes in combination with one or more chemicals.

In currently preferred embodiments of the invention, the said object/plastic is contacted with said one or more enzymes in combination with one or more descaling agents/chemical descalers or water softeners/scale inhibitors.

In particular, at least one of said one or more descaling agents/chemical descalers is an acid, such as a weak acid.

In specific embodiments, the acid is selected from the group consisting of malic acid, citric acid, sorbic acid, lactic acid, phosphoric acid, sulphamic acid and ethanoic acid/acetic acid.

The said one or more water softeners may be selected from the group consisting of a sodium compound and a phosphate.

The sodium compound may in particular be selected from the group consisting of sodium carbonate, sodium metasilicate and sodium borate (borax).

The phosphate may in particular be selected from the group consisting of trisodium phosphate and sodium hexametaphosphate.

In some embodiments, the object made wholly or in part of a plastic is contacted with a composition comprising one or more enzymes, wherein said liquid composition is an alkaline composition. The alkaline composition may have a pH within the range of 8 to 13, such as a pH within the range of 9 to 13, within the range of 10 to 13, within the range of 11 to 13, within the range of 12 to 13, within the range of 8 to 12, within the range of 9 to 12, within the range of 10 to 12, within the range of 11 to 12, within the range of 8 to 11, within the range of 9 to 11, within the range of 10 to 11, within the range of 8 to 10, or within the range of 9 to 10.

In other embodiments, the object made wholly or in part of a plastic is contacted with a composition comprising one or more enzymes, wherein said liquid composition is an acid composition, such as a composition having a pH within the range of 1 to 6, such as a pH within the range of 2 to 6, within the range of 3 to 6, within the range of 4 to 6, within the range of 5 to 6, within the range of 1 to 5, within the range of 2 to 5, within the range of 3 to 5, within the range of 4 to 5, within the range of 1 to 4, within the range of 2 to 4, within the range of 3 to 4, within the range of 1 to 3, within the range of 2 to 6, or within the range of 1 to 2.

Compositions comprising descaling agent(s)/chemical descaler(s) or water softener(s)/scale inhibitors which are useful in the context of the present invention are commercially available, including Suma Soak K7, Diversey Suma, Diversey Coffee Clean, which are all available from Diversey, Inc., Novadan Bistro 742, which is available from Novadan Aps., and Melita Anti-Calc, which is available from Melitta.

The soaking step may have a duration of 5 to 120 minutes, such as a duration of 10 to 120 minutes, 15 to 120 minutes, 30 to 120 minutes, 45 to 120 minutes, 60 to 120 minutes, 5 to 90 minutes, 10 to 90 minutes, 15 to 90 minutes, 30 to 90 minutes, 45 to 90 minutes, 60 to 90 minutes, 75 to 90 minutes, 5 to 60 minutes, 10 to 60 minutes, 15 to 60 minutes, 30 to 60 minutes, 45 to 60 minutes, 5 to 45 minutes, 10 to 45 minutes, 15 to 45 minutes, 30 to 45 minutes, 5 to 30 minutes, 10 to 30 minutes, or such as 15 to 30 minutes.

The said composition may comprise one or more detergent components; in particular, one or more detergent(s) for dishwashing. According to some embodiments, the composition is an automated dishwashing detergent composition; in particular one which comprises one or more components selected from polymers, bleaching systems, bleach activators, bleach catalysts, silicates, dyestuff and metal care agents.

The automated dishwashing detergent composition may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

The automated dishwashing detergent composition may contain 0-30% by weight, such as about 1% to about 20%, of a bleaching system. Any bleaching system known in the art for use in automatic dishwashing detergents may be utilized. Suitable bleaching system components include bleaching catalysts, photobleaches, bleach activators, sources of hydrogen peroxide such as sodium percarbonate, sodium perborates and hydrogen peroxide-urea (1:1), preformed peracids and mixtures thereoflnorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Bleach activators used in the automated dishwashing detergent composition are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups.

Preferred silicates for use in the automated dishwashing detergent composition are sodium silicates such as sodium disilicate, sodium metasilicate and crystalline phyllosilicates. Silicates if present are at a level of from about 1 to about 20%, preferably from about 5 to about 15% by weight of composition

One or more metal care agents may be included to prevent or reduce the tarnishing, corrosion or oxidation of metals, including aluminium, stainless steel and non-ferrous metals, such as silver and copper. Preferably the composition of the invention comprises from 0.1 to 5% by weight of the composition of a metal care agent, preferably the metal care agent is a zinc salt.

The automated dishwashing detergent composition may further comprise one or more alkalis. Non-limiting examples of strong alkalis include e.g. sodium hydroxide, potassium hydroxide, lithium hydroxide, calcium hydroxide or magnesium hydroxide and the detergent composition may comprise a combination of one or more alkalis, such as both sodium hydroxide and potassium hydroxide. The alkali may be present in a level of about 0% to 50%, such as 0.1% to 35%, such as 0.5% to 17%, such as 1% to 12%, such as 1% to 7%, such as 1% to 4% by weight. Since alkalis cause significant wear on the fabric/textile, then it is beneficial to have as little alkali present as possible. Thus a preferred embodiment is less than 17% alkali by weight, such as less than 12% alkali by weight, such as less than 7% alkali by weight, such as less than 4% alkali by weight, such as less than 1% alkali by weight, such as no alkali present.

The automated dishwashing detergent composition composition may also comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%.

One or more hydrotropes may also be included in the automated dishwashing detergent composition composition. A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favour spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behaviour, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The automated dishwashing detergent composition may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

The automated dishwashing detergent composition composition may contain about 0-65% by weight, such as about 5% to about 50% of a detergent builder or co-builder, or a mixture thereof. In a dish wash detergent, the level of builder is typically 40-65%, particularly 50-65%. Any builder and/or co-builder known in the art for use in automatic dishwashing detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The automated dishwashing detergent composition composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid.

The automated dishwashing detergent composition may also comprise one or more sequestering builders. One way of obtaining a low degree of hardness in the wash liquor is by using a strong sequestering builder. The strong sequestering builder should be used in an amount suitable for lowering the hardness of the wash liquor below 3° dH. The strong sequestering builder can be comprised in the ADW detergent composition of the invention.

A strong builder is classified as high efficiency chelators that can bind the divalent cations such as Ca²⁺ strongly with a logarithmic stability constant of the cation/chelator complex of above 4, particular above 5, above 6 or above 7. The stability constants are determined at an ionic strength of 0.1 M and at a temperature of 25° C.

Strong sequestering builders include for example, such materials as water-soluble tripolyphosphate, ethylene diamine tetraacetate, and organic phosphonates. Alkali metal pyrophosphates are also classed as strong sequestering builders. The strong sequestering builder may be a phosphorus-containing builder or a non-phosphorus builder.

Use of strong sequestering builders in order to reduce the hardness of a wash wash liquor to 3° dH or below is disclosed in PCT/EP2014/052616.

Accordingly, the method according to the invention may comprise contacting said object with said one or more enzymes and said one or more descaling agent(s)/chemical descaler(s) or water softener(s)/scale inhibitors during a wash cycle.

As the skilled person will understand, the object made wholly or in part of a plastic may be contacted with said one or more enzymes during one or more wash cycles. According to such embodiments, the one or more enzymes are comprised in the wash liquour or added to the wash liguour during the said one or more wash cycles. Alternatively, the object made wholly or in part of a plastic may be contacted with said one or more enzymes in one or more steps which are separate from the one or more wash cycles; e.g. in a soaking step as defined above. In currently preferred embodiments, the object is contacted with the one or more enzymes enzymes in combination with one or more descaling agent(s)/chemical descaler(s) and/or water softener(s)/scale inhibitors, such as in combination with one or more of the descaling agent(s)/chemical descaler(s) disclosed above and/or in combination with one or more of the water softener(s)/scale inhibitors.

The object is preferably contacted with the one or more enzymes and descaling agent(s)/chemical descaler(s) and/or water softener(s)/scale inhibitors prior to being subject to one or more wash cycles. Hence, the method according to the invention may in som embodiments comprise
i) contacting said object is with a composition comprising said one or more enzymes in combination with said one or more descaling agent(s)/chemical descaler(s) and/or water softener(s)/scale inhibitors, such as in a soaking step as defined above; and subsequently
ii) subjecting said object to one or more wash cycles, such as in a composition comprising a detergent for dishwashing, such as an automated dishwashing detergent composition, as defined above.

According to some embodiments, the said somposition, such as the automated dishwashing detergent composition or said detergent for dishwashing does not contain ester compounds. The use of “ester-free” detergents and detergent compositions are believed to provide an andvantage since esters contribute to formation of the organic film which is removed or reduced according to the invention.

In the method according to the invention, the said object may be subject to the conditions which normally apply in warewash processes, such as to temperatures of 60° C. or higher, and 100% relative humidity (rh).

The said plastic may be selected from the group consisting of polypropylene, acrylic blends, polycarbonate, melamine and any combination thereof. These plastics may all be provided in a form, which is approved, e.g. by the FDA for use in realtion to handling of food and beverages and may be subject to automated warewashing.

In particular, the said plastic may be polycarbonate or melamine. For certain purposes, such a for drinking mugs or cups, polycarbonate is the most preferred plastic as it is clear and durable.

As the skilled person will understand, the method according to the invention is particularly useful in combination with automated warewashing/machine warewashing, such as in industrial and institutional warewashing processes.

The method according to the preceding claims may further comprising the steps of
i) Applying mechanical action in order to release soil and stains form said object; and
ii) rinsing and drying the object.

In certain embodiments, the said object is a mug or a drinking cup, such as a mug or drinking cup made wholly or in part of polycarbonate.

### Prolonging of Lifetime

Another aspect of the present invention pertains to the use of one or more enzymes for prolonging the lifetime of an object made wholly or in part of a plastic, such as an object selected from the group consisting of kitchen utensils, cooking utensils, eating utensils, tableware.

The one or more enzymes may be selected from the particular enzymes disclosed above, and in particular embodiments the invention provides a process, in which said object is contacted with one or more proteases and one or more lipases, such as those disclosed above,

According to some embodiments, the use of one or more enzymes for prolonging the lifetime of said object involves subjecting said object to a soaking step, such as a soaking step defined above.

The use according to the invention of one or more enzymes for prolonging the lifetime of an said object may comprise contacting the said object and/or the said plastic with said one or more enzymes in combination with one or more chemicals as disclosed above.

Also as provided above, the composition may comprise one or more detergent components.

As disclosed above, the said object may in certain embodiments be made wholly or in part of polycarbonate and/or melamine. In particular embodiments, the object is a mug or a drinking cup, such as a mug or drinking cup made wholly or in part of polycarbonate.

Polycarbonate cups and mugs are designed to be resistant to breakage compared to traditional glass cups and mugs. However it is well known within the field that polycarbonate wares often become miscoloured or coated in a film that cannot be removed in normal washing conditions. This reduces the useful lifetime of these wares as their appearance is unappealing in a hospitality or service business. In many cases, the polycarbonate wares are disposed of after 6-12 months of use because of an irreversible film on the surface. This represents a significant cost to owners, and therefore an effective solution to remove this film could have significant benefit for hospitality and restaurant businesses.

### Removal of Malodor

A still further aspect of the invention provides the use of one or more enzymes for removing malodor from an object made made wholly or in part of a plastic, such as an object selected from the group consisting of kitchen utensils, cooking utensils, eating utensils, tableware.

According to some embodiments, the use of one or more enzymes for removing malodor involves subjecting said object to a soaking step, such as a soaking step defined above.

The use according to the invention of one or more enzymes for removing malodor may comprise contacting the said object and/or the said plastic with said one or more enzymes in combination with one or more chemicals as disclosed above.

Also as provided above, the composition may comprise one or more detergent components.

As disclosed above the said object may in certain embodiments be made wholly or in part of polycarbonate and/or melamine. In particular embodiments, the object is a mug or a drinking cup, such as a mug or drinking cup made wholly or in part of polycarbonate

### Composition

The invention also comprises a composition comprising:
I) One or more enzymes as defined above; and
II) one or more detergents and/or one or more chemicals as defined above.

The composition according to the invention may be in any convenient form, e.g., a bar, a homogenous tablet, a tablet having two or more layers, a pouch having one or more compartments, a regular or compact powder, a granulate, a paste, a gel, or a regular, compact or concentrated liquid.

Detergent ingredients as well as chemicals, including descaling agent(s)/chemical descaler(s) or water softener(s)/scale inhibitors, can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

### Method of Making

Additionally, the invention provides method of making a composition as defined above, said method comprising combining one or more enzymes as defined above with one or more detergents and/or chemicals as defined above.

### Kit of Parts

Finally, the invention provides a kit of parts comprising:

I) One or more enzymes as defined above; and

II) one or more detergents and/or one or more chemicals as defined above.

The present invention is further described by the following examples that should not be construed as limiting the scope of the invention.

### EXAMPLES

### Example 1: Trials with Various Cleaning Agents and Enzymes

Aim: To determine the film removal capability of various washing/cleaning chemicals when combined with enzymes.

### Materials

### Polycarbonate Mugs:

250 mL clear polycarbonate Glass4Ever coffe mugs collected from a local canteen in a company in Denmark, where the mugs had been in circulation and exposed to general use conditions (tea, coffee, hot chocolate, fruit teas) for between 6-12 months

### Enzymes:

### Lipex 100L SEQ ID NO: 7.

### Esperase 8.0L, SEQ ID NO: 6

### Soaking Detergents:

Suma Soak K7—sodium carbonate, alcohols C13-C15 ethoxylated
Suma Coffeeclean—potassium hydroxide, sodium hypochlorite, water
Melitta Coffee Machine Scale Remover—citric acid, lactic acid, water

### Warewash Detergents:

Ecolab Topmatic Clean—sodium hydroxide
Ecolab Clear Dry Classic rinse aid—Fatty alcohol ethoxylates ≦C15 and ≦5EO, Alcohol ethoxylate, sodium cumenesulphonate, Propan-2-ol

### Method

Mugs are visually rated before the trial starts
The soaking detergents and enzymes are blended in 50° C. water. Soaking detergents were dosed at 10 g/L. Melitta Coffee Machine Scale Remover was added at 50 g/L.
The solutions are added to the mugs, and they are allowed to soak for 60 minutes
After 60 minutes, the mugs are emptied, and then washed once in a Hobart AUXX hooded warewash machine (52 sec program, 65° C. wash, 82° C. rinse. Ware wash detergent dosed at 2.5 g/L and rinse aid at 0.35 g/L)
After drying by hand with a soft cloth, the mugs are again visually rated

### Results

Results are shown in Table 1. Ratings are based on a visual assessment of the mugs before and after washing. A rating of 1 indicates an as new mug, while 5 indicates severe, opaque filming.

TABLE 1

| | Soaking | Enzyme/s | Description | Rating | | Rating |
|---|---|---|---|---|---|---|
| Mug# | Solution | Applied | before | before | Description after | after |
| 10 | Suma Soak | Lipex 100 L | Partly coated | 3 | Most of the | 2 |
| | K7 | (19 mg- | with some white | | coating/white film | |
| | | aep/L) | film or scaling | | has disappeared. | |
| | | Esperase | | | Only a few | |
| | | 8.0 L (34 mg- | | | scaling spots | |
| | | aep/L) | | | remain | |
| 11 | Suma | Lipex 100 L | White coating | 4 | Reduction in the | 2 |
| | Coffeeclean | (19 mg- | on inside along | | coating but still | |
| | | aep/L) | with some white | | with some white | |
| | | Esperase | spots | | spots | |
| | | 8.0 L (34 mg- | | | | |
| | | aep/L) | | | | |
| 12 | Suma Soak | Lipex 100 L | White shadow | 5 | Still some film left | 2 |
| | K7 | (38 mg- | or scaling inside | | but strongly | |
| | | aep/L) | the cup. Also a | | reduced, except | |
| | | Esperase | bit of brown | | from bottom. | |
| | | 8.0 L (68 mg- | color. Thick film | | Visible brown | |
| | | aep/L) | in the bottom | | color, but this is | |
| | | | | | removed when | |
| | | | | | drying | |
| 13 | Melitta | Lipex 100L | White shadow | 5 | Film almost | 2 |
| | Coffee | (19 mg- | or scaling inside | | totally gone, | |
| | Scale | aep/L) | the cup. Also a | | except from in | |
| | Remover | Esperase | bit of brown | | the bottom. Weak | |
| | | 8.0L (34 mg- | color. Thick film | | brown color still | |
| | | aep/L) | in the bottom | | visisble. | |
| 14 | Water | Lipex 100 L | Weak white | 4 | Reduced film but | 3 |
| | | (19 mg- | coating and a | | still very visible | |
| | | aep/L) | big scaling circle | | | |
| | | Esperase | at the middle | | | |
| | | 8.0 L (34 mg- | | | | |
| | | aep/L) | | | | |

### CONCLUSIONS

In each case, there was a reduction in the film present on the mugs.
The best result was seen when the enzymes were applied together with the Melitta scale remover. This is surprising given the acidic environment in the scale remover solution and that the enzymes used have an optimal operational pH that is alkaline.
While not providing the optimal conditions for enzyme application, the results indicate the combination of enzymatic action and scale removal action provides the best conditions for film removal.
The brown coloured stain that is present on some mugs cannot be removed. The detergents do not impact this stain, and neither do the enzymes. However, it has been noticed that if enzymes are applied then the stain can be easily removed by wiping the inside of the mugs with a soft cloth.

### Example 2: Enzymatic Trials with Diversey Soaking Detergent

Aim: This experiment aims to determine the effect of a combination of enzymes and a common soaking detergent will have on the film.

### Materials

### Polycarbonate Mugs:

250 mL clear polycarbonate Glass4Ever™ coffe mugs
Collected from a local canteen in a company in Denmark, where the mugs had been in circulation and exposed to general use conditions (tea, coffee, hot chocolate, fruit teas) for between 6-12 months

### Enzymes:

### Lipex 100L

### Esperase 8.0L

### Soaking Detergent:

Suma Soak K7—sodium carbonate, alcohols C13-C15 ethoxylated

### Warewash Detergents:

Ecolab Topmatic Clean—sodium hydroxide
Ecolab Clear Dry Classic rinse aid—Fatty alcohol ethoxylates ≦C15 and ≦5EO, Alcohol ethoxylate, sodium cumenesulphonate, Propan-2-ol

### Method

Mugs are visually rated before the trial starts
The soaking detergents and enzymes are blended in 20° C. water. Soaking detergents were added at 10 g/L.
The solutions are added to the mugs, and they are allowed to soak for 60 minutes
After 60 minutes, the mugs are emptied, and then washed once in a Hobart AUXX hooded warewash machine (52 sec program, 65° C. wash, 82° C. rinse. Ware wash detergent dosed at 2.5 g/L and rinse aid at 0.35 g/L)
After drying by hand with a soft cloth, the mugs are again visually rated

### Results

Results are shown in Table 2. Ratings are based on a visual assessment of the mugs before and after washing. A rating of 1 indicates an as new mug, while 5 indicates severe, opaque filming.

TABLE 2

| | Soaking | Enzyme/s | Description | Rating | | Rating |
|---|---|---|---|---|---|---|
| Cup# | Solution | Applied | before | before | Description after | after |
| 20 | Suma | Lipex 100 L | A few white | 3 | Most of spots | 2 |
| | Soak K7 | (19 mg- | scale circles, | | and scaling | |
| | | aep/L) | One larger | | gone. Still some | |
| | | Esperase | brown spot in the | | brown color/spot | |
| | | 8.0 L (34 mg- | bottom of the | | left | |
| | | aep/L) | cup. Partly | | | |
| | | | coated— | | | |
| | | | top/bottom | | | |
| 21 | Suma | Lipex 100 L | A white and | 4 | A clear reduction | 2 |
| | Soak K7 | (19 mg- | brown thick | | of the coating. | |
| | | aep/L) | coating in the | | Some left of the | |
| | | Esperase | whole cup | | brown | |
| | | 8.0 L (34 mg- | | | color/circles | |
| | | aep/L) | | | | |
| 22 | Suma | Lipex 100 L | An obvious white | 3 | Reduction of | 2 |
| | Soak K7 | (19 mg- | film in ¾ of the | | film, with only a | |
| | | aep/L) | cup and some | | little visible when | |
| | | Esperase | white scaling | | held up to light | |
| | | 8.0 L (34 mg- | spots | | | |
| | | aep/L) | | | | |
| 23 | Suma | Lipex 100 L | Very thick white | 5 | All scaling and | 1 |
| | Soak K7 | (19 mg- | film in the whole | | spots gone | |
| | | aep/L) | cup and also | | | |
| | | Esperase | white spots and | | | |
| | | 8.0 L (34 mg- | soil | | | |
| | | aep/L) | | | | |
| 24 | Suma | Lipex 100 L | White film on the | 4 | Godd reduction | 2 |
| | Soak K7 | (19 mg- | cup, also some | | in film, but some | |
| | | aep/L) | circles | | scale left | |
| | | Esperase | | | | |
| | | 8.0 L (34 mg- | | | | |
| | | aep/L) | | | | |

### CONCLUSION

The results indicate that the combination of Diversey Suma K7, Lipex 100L and Esperase 8.0L generally has a very positive effect on film removal from the polycarbonate mugs.
In the best case, a reduction of 5 points was achieved, returning the mug to an as new condition.
These are exceptional results given the inability of the kitchens to clean the mugs using common warewash chemicals and even hand scrubbing of the mugs. It is surprising that the enzymes can remove significant amounts of the film in a short period (60 mins) at room temperature and without any physical action.
It is clear that some scaling is present in the mugs, which is a common phenomenon in warewashed plastics. This cannot be removed by the enzymes or the alkaline soaking detergent.

### Example 3: Enzymatic Removal of Film in a Wasrewasher

Aim: Determine the effect of enzymes for removing film from polycarbonate mugs in a warewawsh process.

### Materials

### Polycarbonate Mugs:

250 mL clear polycarbonate Glass4Ever coffe mugs
Collected from a local canteen in a company in Denmark. The mugs had been in circulation and exposed to general use conditions (tea, coffee, hot chocolate, fruit teas) for between 6-12 months

### Enzymes:

### Lipex 100L

### Esperase 8.0L

### Warewash Detergents:

Diversey Suma Nova L6—Tetrasodium-ethylene diamine tetra acetic acid, sodium hydroxide
Diversey Suma Select Free A7—Alcohols, C13-C15-branchend and linear butoxylated ethoxylated, poly(ethylene glycol-co-propylene glycol) monobutyl ether, sodium cumenesulphonate

### Ballast Soil:

A blend of margarine, lard, frying oil, brown sauce powder, rape seed oil, egg yolk, egg white, tomato ketchup, mustard, cream, full cream milk, potato flour, wheat flour, cheese powder.

### Method

Mugs are visually rated before the trial starts
Ballast soil is added to the Hobart AUXX hooded warewash machine sump to a concentration of 1 g/L
Enzymes are added to the Hobart AUXX hooded warewash machine sump to a concentration of 3.4 mg-aep/L (mg active enzyme protein/Liter) Esperase 8.0L and 1.9 mg-aep/L Lipex 100L.
The mugs are placed in a warewashing rack and washed 40 times (Hobart AUXX hooded warewash machine (52 sec program, 65° C. wash, 82° C. rinse. Detergent dosed at 2.5 g/L and rinse aid at 0.35 g/L)), with ballast soil and enzymes added in the appropriate amount after each wash.
After drying by hand with a soft cloth, the mugs are again visually rated

### Results

Results are shown in Table 3. Ratings are based on a visual assessment of the mugs before and after washing. A rating of 1 indicates an as new mug, while 5 indicates severe, opaque filming.

TABLE 3

| | | Rating | | Rating |
|---|---|---|---|---|
| Cup# | Description before | before | Description after | after |
| 45 | Some film and scaling | 4 | Cloudy film reduction, | 3 |
| | in the whole cup. | | and less dirt in bottom | |
| | Dirty in bottom | | | |
| 46 | Significant white | 3 | Reduction in spots and | 2 |
| | filming and spots | | some scaling but still | |
| | | | some film left | |
| 47 | White scaling and also | 3 | Small overall | 2 |
| | some brown spots | | reduction | |
| 48 | Scaling and film in | 3 | Scaling and film | 2 |
| | lower ½ of cup. | | reduced. Dirt in top | |
| | Dirty in top | | gone | |
| 49 | Significant film, spots | 5 | Scaling strongly | 3 |
| | and circles in the | | reduced but still some | |
| | whole cup | | filmed areas left | |

### CONCLUSIONS

Film removal in a warewashing process was seen in this experiment.
In all cases there was at least a 1 point reduction in filming, but this is still much less than in soaking processes. This result indicates that the enzymatic cleaning effect is on the surface of the mugs (directly on the film).
Increasing the active lifetime of enzymes in the sump will likely lead to improved performance.
Foaming was an issue during operation.

In general, the experiments undertaken in the Hobart warewasher have demonstrated that the enzymes have an effect on the film under a warewash process. However, the enzymes are not as effective as the soaking process in completely removing the film.

Based on these results, enzymes could have a double role to play. Firstly, a soaking process could be used to clean the filmed cups and bring them back to an “as new” state.

Secondly, enzymes could become part of the chemicals added to the warewashing process, where the demonstrated effect could be used to prevent film formation on the cups, and thereby maintain the “as new” condition of the cups over a much longer period.

### Example 4: Reduction in Odour Through the Application of Enzymes

Aim: This experiment is to determine the effectiveness of enzymes in reducing or removing the offending odours from polycarbonate drinking mugs.

### Materials

### Polycarbonate Mugs:

250 mL clear polycarbonate Glass4Ever coffe mugs
Collected from a local canteen in a company in Denmark. The mugs had been in circulation and exposed to general use conditions (tea, coffee, hot chocolate, fruit teas) for between 6-12 months

### Enzymes:

### Lipex 100L

### Esperase 8.0L

### Soaking Detergents:

Suma Soak K7—sodium carbonate, alcohols C13-C15 ethoxylated
Suma Coffeeclean—potassium hydroxide, sodium hypochlorite, water

### Warewash Detergents:

Ecolab Topmatic Clean—sodium hydroxide
Ecolab Clear Dry Classic rinse aid—Fatty alcohol ethoxylates ≦C15 and ≦5EO, Alcohol ethoxylate, sodium cumenesulphonate, Propan-2-ol

### Method

Mugs are visually rated before the trial starts
The soaking detergents and enzymes are blended in 20° C. water. Soaking detergents were added at 10 g/L.
The solutions are added to the mugs, and they are allowed to soak for 60 minutes
After 60 minutes, the mugs are emptied, and then washed once in a Hobart AUXX hooded warewash machine (52 sec program, 65° C. wash, 82° C. rinse. Ware wash detergent dosed at 2.5 g/L and rinse aid at 0.35 g/L)
After drying by hand with a soft cloth, the mugs are again visually rated

### Results

Results are shown in Table 4. Ratings are based on a visual and odour assessment of the mugs before and after washing. A rating of 1 indicates an as new mug, while 5 indicates severe filming/odour.

TABLE 4

| | | | Visual | Smell | | Visual | Smell | |
|---|---|---|---|---|---|---|---|---|
| | Soaking | Enzyme/s | rating | rating | Description | rating | rating | Description |
| Cup# | Solution | Applied | before | before | before | after | after | after |
| 1 | Water | None | 2 | 2 | Some spots. | 2 | 2 | Some spots. |
| | | | | | Only a slight | | | Only a slight |
| | | | | | odour | | | odour |
| 2 | Boiling | None | 3 | 3 | Some | 3 | 2 | Some |
| | Water | | | | scaling. | | | scaling. A |
| | | | | | Distinctive | | | slight fruity |
| | | | | | fruity odour | | | odour |
| 3 | Suma | None | 3 | 2 | White spots | 3 | 2 | White spots |
| | Coffeeclean | | | | and some | | | and some |
| | | | | | scaling. | | | scaling. |
| | | | | | Smell is not | | | Smell is not |
| | | | | | that strong | | | that strong |
| 4 | Suma Soak | None | 3 | 3 | Some | 3 | 3 | Some |
| | K7 | | | | scaling. | | | scaling. A |
| | | | | | Distinctive | | | slight fruity |
| | | | | | fruity odour | | | odour |
| 5 | Water | Lipex | 4 | 4 | Strong white | 2 | 2 | Little film |
| | | 100 L (19 | | | film. Smells | | | remaining, |
| | | mg- | | | very fruity | | | slight odour |
| | | aep/L) | | | | | | |
| | | Esperase | | | | | | |
| | | 8.0 L (34 | | | | | | |
| | | mg-aep/L) | | | | | | |
| 6 | Suma | Lipex | 2 | 2 | White film | 2 | 2 | White film |
| | Coffeclean | 100 L (19 | | | visible, | | | visible. |
| | | mg- | | | Slight odour. | | | Slight odour. |
| | | aep/L) | | | | | | |
| | | Esperase | | | | | | |
| | | 8.0 L (34 | | | | | | |
| | | mg-aep/L) | | | | | | |
| 7 | Suma Soak | Lipex | 4 | 4 | Some | 3 | 2 | Some |
| | K7 | 100 L (19 | | | scaling and | | | scaling and |
| | | mg- | | | spots. | | | rings. Brown |
| | | aep/L) | | | Brown color | | | color. Smell |
| | | Esperase | | | smells | | | is reduced |
| | | 8.0 L (34 | | | strongly of | | | but still |
| | | mg-aep/L) | | | coffee | | | slightly |
| | | | | | | | | noticeable |
| 12 | Water | Lipex | 4 | 5 | Scaling, film | 2 | 2 | Scaling still |
| | | 100 L (19 | | | and weak | | | present. |
| | | mg- | | | brown color. | | | Smell very |
| | | aep/L) | | | Smell is | | | reduced but |
| | | Esperase | | | strongly | | | still a weak |
| | | 8.0 L (34 | | | fruity | | | fruity odour |
| | | mg-aep/L) | | | | | | |

### CONCLUSIONS

It is clear that the enzymes have a significant effect for removing the odour present in the mugs.
When looking at the visual and odour ratings before treatment, it appears that there is a direct correlation between the amount of film observed and the odour experienced.
In the cases where only water and enzymes were used, the best results were achieved.
The detergents alone had little to no effect, and certainly much less than that observed when applying enzymes.
   Overall Conclusions from Experiments:
Water alone had no effect on the film.
There was some effect when the enzymes or detergents were used independently. However, when a detergent and the enzymes were used together, a very satisfactory result was achieved.
The experiments have shown that the application of a combination of lipase and protease can in some cases remove nearly 100% of the film and return the material to an “as new” appearance. Variations in results are likely due to variations in the film on the polycarbonate material, the age of the polycarbonate material and the treatments the polycarbonate material has been exposed to previously.
The results were achieved without any physical labour from the operators, indicating that a soaking based solution as outlined could lead to a saving of labour costs. The results were achieved without applying any harsh treatments that can damage the surface of the mugs. This would lengthen the lifetime of the mugs and reduce costs to the owner.
The removal of the film and odour in the mugs will enhance the user experience and reduce flavour carry over (for example from a cup of fruit tea to a following cup of coffee), increasing user satisfaction.

1. A method for cleaning an object made wholly or in part of a plastic, comprising contacting said object/said plastic with a liquid composition comprising one or more enzymes.

2. The method according to claim 1, said method being for complete or partial removal of an organic film on said plastic.

3. The method according to claim 1, wherein the organic film comprises carbonates, including calcium carbonate (CaCO₃) and magnesium carbonate (MgCO₃), magnesium hydroxide (Mg(OH)₂), calcium sulfate (CaSO₄), and one or more organic compounds, such as one or more compounds selected from the group consisting of esters, amino acids, peptides and proteins.

4. The method according to claim 1, said method being for reduction or removal of malodor.

5. The method according to claim 1, wherein said object is selected from the group consisting of kitchen utensils, cooking utensils, eating utensils, tableware.

6. The method according to claim 1, wherein the object is contacted with said one or more enzymes in a soaking step.

7. The method according to claim 1, wherein the object is contacted with said one or more enzymes in a soaking step, wherein the total amount of said one or more enzymes in said liquid composition is within the range of 0.05-5% (w/w).

8. The method according to claim 1, wherein said or more enzymes are selected from the group consisting of proteases and lipases.

9. The method according to claim 1, wherein said object is contacted with one or more proteases and one or more lipases.

10. The method according to claim 9, wherein from 10-20% of the amount of enzyme is protease.

11. The method according to claim 9, wherein from 80-90% of the amount of enzyme is lipase.

12. The method according to claim 1, wherein at least one of said one or more proteases is an alkaline protease, such as a subtilisin.

13. The method according to claim 1, wherein at least one of said one or more proteases is selected from the group consisting of Bacillus lentus proteinase (Esperase 8.0L), Bacillus subtilis alkaline proteinase (savinase).

14. The method according to claim 1, wherein the protease has at least 80%, identity to SEQ ID NO: 6.

15. The method according to claim 1, wherein at least one of said one or more lipases is selected from the group consisting of Lipex100L.

16. The method according to claim 1, wherein the lipase has at least 80%, identity to SEQ ID NO: 7.

17. The method according to claim 1, wherein the protease has at least 80%, identity to SEQ ID NO: 6 and said lipase has at least 80%, identity to SEQ ID NO: 7.

18. The method according to claim 1, wherein said object/the plastic is contacted with said one or more enzymes in combination with one or more chemicals.

19. The method according to claim 18, wherein said object/plastic is contacted with said one or more enzymes in combination with one or more descaling agent(s)/chemical descaler(s) or water softener(s)/scale inhibitors.

20. The method according to claim 18, wherein at least one of said one or more descaling agent(s)/chemical descaler(s) is an acid, such as a weak acid.

21-47. (canceled)
